(19) United States
(12) Patent Application Publication
(10) Pub. No.: US 2008/0260626 A1
(43) Pub. Date: Oct. 23, 2008

(54) Photocatalysts Based on Titanium Dioxide

(76) Inventors: Stephan Peter Bloss, Burscheid (DE); Bruno Charruey, Etrechy (FR); Lothar Elfenthal, Langenfeld (DE); Peter Gross, Ludwigshafen (DE); Volker Schmitt, Leichlingen (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/046,149

(22) Filed: Mar. 11, 2008

Related U.S. Application Data
(60) Provisional application No. 60/913,371, filed on Apr. 23, 2007.

(30) Foreign Application Priority Data
Apr. 20, 2007 (DE) 10 2007 019 040.0

(51) Int. Cl. C01G 23/047; B01J 27/043

(52) U.S. Cl. 423/610; 502/222

(57) ABSTRACT

A powdery photocatalyst based on titanium dioxide displays a bimodal particle size distribution of primary particles, with one particle component under about 30 nm and a second particle component over about 100 nm. The photocatalyst is manufactured by mixing at least two TiO₂ components. One component is a TiO₂ photocatalyst which is active in UV light and/or in visible light and which displays a specific surface according to BET of at least about 120 m²/g. The second component is anatase and/or rutile displaying a specific surface according to BET of less than about 50 m²/g. The two components are contained in the photocatalyst at a weight ratio of 1:1000 to 1000:1.

### RELATED APPLICATIONS

This application claims the benefit of U.S. Provisional Patent Application Ser. No. 60/913,371 filed Apr. 23, 2007 and the benefit of German Patent Application Serial No. DE 10 2007 019 040.0 filed Apr. 20, 2007.

### TECHNICAL FIELD OF THE INVENTION

The invention relates to photocatalysts based on titanium dioxide that are active in UV light and in visible light, as well as methods for manufacturing them.

### BACKGROUND OF THE INVENTION

Photocatalytic materials are semiconductors in which, when exposed to light, electron-hole pairs are formed that generate highly reactive free radicals on the material surface. Titanium dioxide is a semiconductor of this kind.

It is known practice to use titanium dioxide to remove natural and artificial contamination in gaseous and aqueous systems by irradiation with UV light (uvlp TiO₂). Moreover, titanium dioxide can be modified in such a way that the photocatalytic effects also occur upon exposure to visible light with a wavelength in the spectral range from about 400 to 700 nm (vlp TiO₂). Modification is performed, for example, by doping the TiO₂ structure with metal ions, such as Cr or Mn (e.g. WO 99/033564 A1), with nitrogen (e.g. U.S. Pat. No. 6,827,922 B2) or with carbon (e.g. US 2005/0226761 A1), and leads to energy states in the band gap of the TiO₂ crystal lattice.

Titanium dioxide occurs in two commercially significant crystalline phases, anatase and rutile. Anatase has a band gap of 3.2 eV, corresponding to a UV wavelength of 385 nm. Owing to its low electron-hole recombination rate, anatase is the photocatalytically more active phase. Rutile, on the other hand, has a band gap of 3.0 eV and is photocatalytically less active.

Non-doped, commercially available, UV-active TiO₂ photocatalysts are often anatases (e.g. Sachtleben Hombikat UV 100, Ishihara ST-01 and ST-21), but also rutiles (e.g. Ishihara PT-101, Toho NS-51). The P-25 TiO₂ photocatalyst from Degussa consists of anatase (approx. 80%) and rutile (approx. 20%). Doped TiO₂ photocatalysts active in visible light are crystalline or amorphous to microcrystalline anatase (US 2005/0227854 A1), and products manufactured and sold by Kronos as vlp 7000 and vlp 7001. The photocatalytic efficacy of the individual photocatalysts depends both on the crystal structure (band gap) and on the capacity to adsorb organic compounds and the recombination rate of electrons and holes.

### SUMMARY OF THE INVENTION

The present invention provides a TiO₂ photocatalyst with increased efficacy that can be manufactured simply and inexpensively compared to the prior art, and includes a manufacturing method.

The present invention includes a powdery photocatalyst based on titanium dioxide, characterised in that the photocatalyst displays a bimodal particle size distribution of the primary particles, with one particle fraction under about 30 nm and a second particle fraction over 100 nm.

The present method for manufacturing a photocatalyst based on titanium dioxide is characterised in that at least two TiO₂ components are mixed, where one component is a uvlp TiO₂ or a vlp TiO₂ or a mixture thereof with a specific surface area according to BET of at least about 120 m²/g, and where a second component is anatase or rutile or a mixture thereof with a specific surface area according to BET of less than about 50 m²/g.

### BRIEF DESCRIPTION OF THE DRAWINGS

For a more complete understanding of the present invention and for further advantages thereof, reference is now made to the following description taken in conjunction with the accompanying drawings in which:

FIGS. 1 and 2 are scanning electron microscope photographs of uv/vlp TiO₂ particles attached to the surface of crystalline TiO₂ particles; and

FIG. 3 is a bar chart of relative photoactivity for mixtures containing rutile, anatase, rutile and anatase, and pure photocatalyst.

### DESCRIPTION OF THE PREFERRED EMBODIMENTS

As used herein, the term “vlp TiO₂” (vlp: visible-light photocatalyst) is used to mean all photocatalysts active in visible light, the term “uvlp TiO₂” is used to mean all photocatalysts active only in the UV range.

The term “primary particles” denotes all visually distinguishable particles in scanning electron microscope photographs with a point resolution of 2 nm.

All data disclosed below regarding temperature, concentration in parts by weight, etc., are to be interpreted as including all values lying in the range of the respective measuring accuracy known to the person skilled in the art. When used in the context of the present description, the term “significant quantity” or “significant content” indicates the minimum quantity of a component, upwards of which the properties of the mixture are affected in the framework of the measuring accuracy.

The photocatalyst according to the present invention displays a bimodal particle size distribution of the primary particles, with one particle fraction under about 30 nm and with a second particle fraction over about 100 nm. The photocatalyst contains at least two TiO₂ components. The first component is a photoactive TiO₂ component (uvlp TiO₂ or vlp TiO₂ or a mixture thereof) with a particle size under about 30 nm, herein referred to as “uv/vlp TiO₂”. The uv/vlp TiO₂ has a specific surface area according to BET (Brunauer-Emmett-Teller) of at least about 120 m²/g, preferably at least about 150 m²/g, particularly at least about 250 m²/g. The second component is anatase or rutile or a mixture thereof with a particle size over about 100 nm, herein referred to as “crystalline TiO₂”. The crystalline TiO₂ has a specific surface area according to BET of less than about 50 m²/g, preferably less than about 20 m²/g, and particularly about 7 to 12 m²/g. The crystalline TiO₂ is preferably not surface-treated.

The first and the second component are contained in the photocatalyst according to the present invention at a weight ratio of 1:1000 to 1000:1, preferably 1:100 to 100:1, and particularly preferably 1:10 to 10:1.

In an embodiment of the present invention the TiO₂ components originate from the so-called sulphate process for producing titanium dioxide. In this context, titaniferous raw materials, particularly iron-titanium ore, are digested in sulphuric acid, the titanium content then being separated in the form of titanyl sulphate, hydrolysed, and the titanium oxyhydrate dehydrated and in converted into TiO₂ in a calciner (e.g. rotary kiln).

To produce an effective uvlp photocatalyst, the amorphous titanium oxyhydrate is dried, heat-treated at moderate temperatures (about 50 to 500° C.), or vacuum or freeze-dried.

To produce an effective vlp TiO₂, a suitable doping agent is added to the titanium oxyhydrate prior to heat treatment. For example, US 2005/0226761 A1 describes the manufacture of a C-doped vlp TiO₂ by admixing carbon-containing substances, such as hydrocarbons with at least one functional group.

Compared to TiO₂ photocatalysts produced by other methods, the phases from the sulphate method are characterised by a higher SO₃ content and a higher Fe content. As a rule, the SO₃ content is about 100 ppm. The Fe content is about 5 ppm.

Production of the photocatalyst according to the present invention starts with the dry, powdery components. The components are mixed mechanically. Customary mixing units, such as drum mixers or ploughshare mixers, are suitable for this purpose. Mixing can also be performed in the form of a slurry in a dispersing machine, such as an agitator mill.

The uv/vlp TiO₂ and the crystalline TiO₂ are mixed at a weight ratio of 1:1000 to 1000:1. Advantageous results are obtained with mixing ratios of 1:100 to 100:1, and particularly of 1:10 to 10:1.

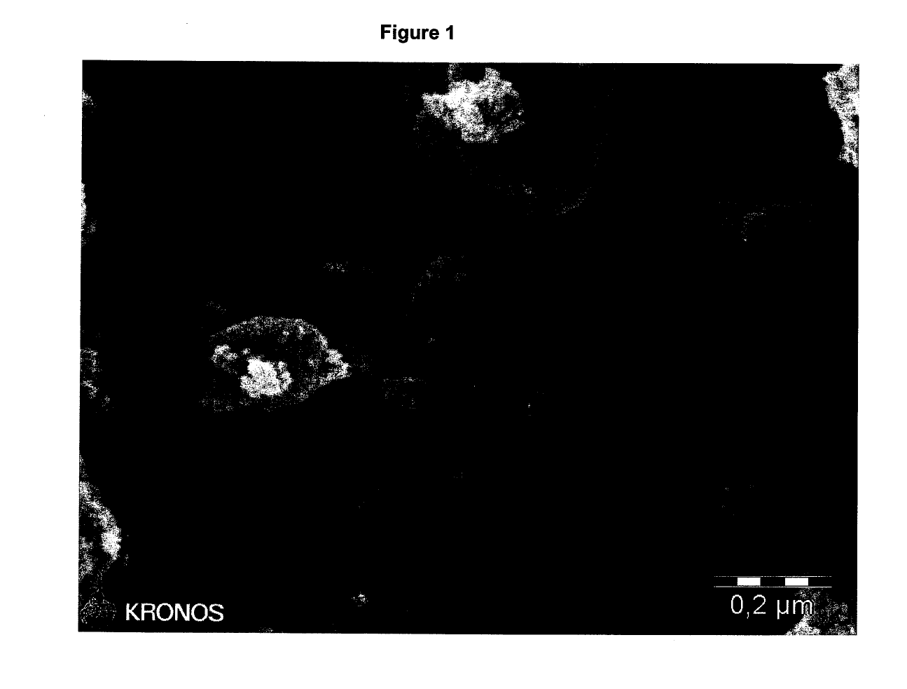

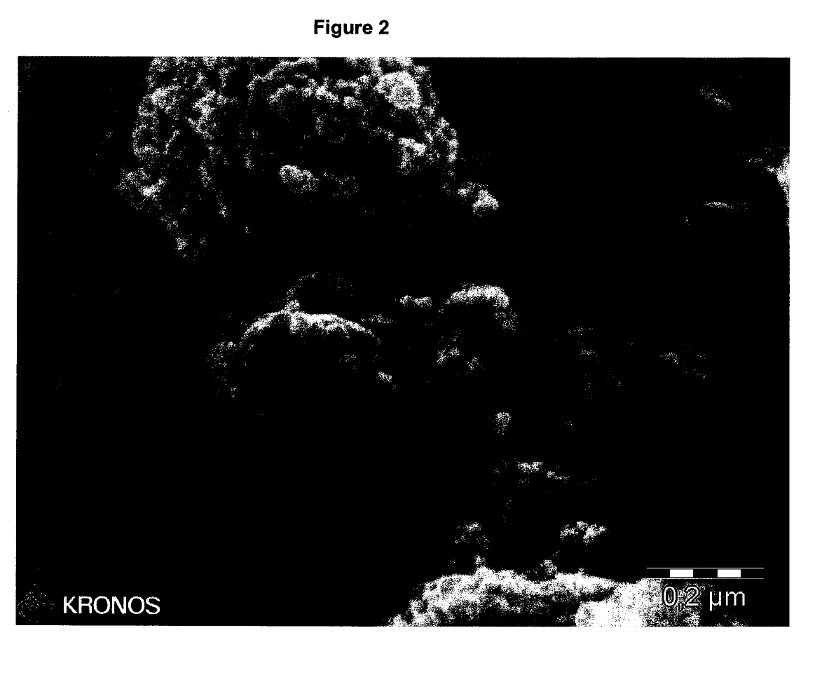

Surprisingly, the photocatalysts according to the present invention display greater efficacy than would be expected from the individual components. Scanning electron microscope photographs show that the uv/vlp TiO₂ particles attach themselves to the surface of the crystalline TiO₂ particles (FIGS. 1 and 2). A junction is possibly formed between the band structures of the two components (see D. C. Hurum et al., “Recombination Pathways in the Degussa P25 Formulation of TiO₂: Surface versus Lattice Mechanisms”, J. Phys. Chem. B, Vol. 109, No. 2 (2005) p. 977-980).

The photocatalyst according to the present invention can advantageously be applied in a thin film to various substrates, such as glass (plain and metal-coated), wood, fibres, ceramics, concrete, building materials, SiO₂, metals, paper and plastics. In combination with simple production, potential applications include diverse sectors, such as the construction, ceramic and automotive industries, for self-cleaning surfaces, or in environmental engineering (air-conditioning equipment, equipment for air purification and air sterilization, and in water purification, particularly drinking water, e.g. for antibacterial and antiviral purposes).

The photocatalyst can further be used in coatings for indoor and outdoor applications, e.g. paints, plasters, lacquers and glazes for application to masonry, plaster surfaces, coatings, wallpapers and wood, metal, glass, plastic or ceramic surfaces, or to components, such as composite heat insulation systems and curtain wall elements, as well as in road surfacings and in plastics, plastic films, fibres and paper. The photocatalyst can moreover be used in the production of prefabricated concrete elements, concrete paving stones, roof tiles, ceramics, tiles, wallpapers, fabrics, panels and cladding elements for ceilings and walls indoors and outdoors. When used as a coating on substrates or in coatings, the photocatalyst can additionally inhibit algae growth and thus, for example, protect the surface of boats or other parts exposed to water against undesirable fouling with algae.

Technical processing can be performed both dry and in a slurry or in a matrix.

### EXAMPLES

The present invention is explained in greater detail on the basis of the examples below, without this being intended to restrict the invention.

Dry-homogenised, powdery mixtures with the following mass ratios were produced using the components vlp TiO₂, uvlp TiO₂, untreated anatase and untreated rutile:

| vlp TiO₂ | Anatase | Rutile |
|---|---|---|
| 1 | — | — |
| 0.5 | — | 0.5 |
| 0.5 | 0.5 | — |
| 0.33 | 0.33 | 0.33 |

| uvlp TiO₂ | Anatase | Rutile |
|---|---|---|
| 1 | — | — |
| 0.5 | — | 0.5 |
| 0.5 | 0.5 | — |
| 0.33 | 0.33 | 0.33 |

The particle fractions under about 30 nm and over about 100 nm can be detected in all mixtures under the scanning electron microscope. As examples, FIG. 1 and FIG. 2 show scanning electron microscope photographs of the vlp TiO₂/rutile mixture and the uvlp TiO₂/anatase mixture, respectively.

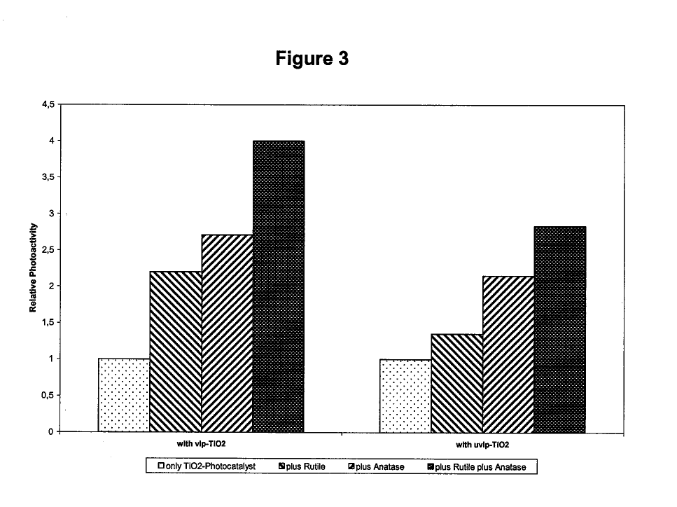

The mixtures were tested as regards their photoactivity. FIG. 3 shows that the mixtures containing rutile or anatase, or rutile and anatase, demonstrate increased photoactivity compared to the pure photocatalyst, and referred to the quantity of photocatalyst in the mixture.

Test Methods

Scanning Electron Microscope

The photographs of FIGS. 1 and 2 were taken using a LEO 1530VP scanning electron microscope from ZEISS. The samples were coated with gold beforehand.

Specific Surface Area to BET (Brunauer-Emmett-Teller)

The BET surface was measured according to the static volumetric principle, using a Tristar 3000 from Micromeritics.

Photoactivity Measurements

The photoactivity measurements were performed with the help of the white lead/glycerine test (PbG). Comparable tests are described in the prior art, e.g. in R. L. Gerteis & A. C. Elm, “Photochemistry of Titanium Dioxide Pigments and its Relationship to Chalking”, J. Paint Technol. Vol. 43, No. 555 (1971) p. 99-106 and U.S. Pat. No. 3,981,737. The test method involves preparation of an aqueous paste containing the TiO₂ photocatalyst to be tested, glycerol and basic lead carbonate at a mass ratio of 1:2.27:0.09. The paste is subsequently irradiated with an OSRAM Vitalux lamp (300 W, 230 V). The grey discolouration of the paste, induced by the photoreaction, is monitored over time by means of reflectance measurements and is a measure of the photoactivity of the photocatalyst. Under the given conditions, photocatalysts with higher photoactivity more rapidly lead to greying of the paste than photocatalysts with lower photoactivity. The “relative photoactivity” (FIG. 3) was calculated from the grey value measured after 12 minutes of exposure in relation to the initial grey value, and referred to the photocatalyst content of the mixture by mass.

We claim:

1. A powdery photocatalyst based on titanium dioxide, comprising:
a bimodal particle size distribution of primary particles, with one component under about 30 nm and a second component over about 100 nm.

2. The photocatalyst of claim 1, further comprising:
at least two TiO₂ components.

3. The photocatalyst of claim 2, whereby:
the TiO₂ components include an Fe content at least about 5 ppm, referred to TiO₂, and an SO₃ content at least about 100 ppm, referred to TiO₂.

4. The photocatalyst of claim 2, whereby:
one TiO₂ component is uv/vlp TiO₂ with a particle size under about 30 nm, and a second TiO₂ component is crystalline TiO₂ with a particle size greater than about 100 nm.

5. The photocatalyst of claim 1 whereby:
the photocatalyst is incorporated in devices for air and water purification.

6. A powdery photocatalyst based on titanium dioxide, comprising:
a mixture of at least two TiO₂ components,
whereby a first TiO₂ component is uv/vlp TiO₂ with a specific surface area according to BET of at least about 120 m²/g, and whereby a second TiO₂ component is crystalline TiO₂ with a specific surface area according to BET of less than about 50 m²/g.

7. A material containing a photocatalyst based on titanium dioxide whereby:
said photocatalyst displays a bimodal particle size distribution of primary particles, with one component under about 30 nm and a second component over about 100 nm.

8. A method for manufacturing a photocatalyst based on titanium dioxide, comprising:
mixing of at least two TiO₂ components,
whereby a first TiO₂ component is uv/vlp TiO₂ with a specific surface area according to BET of at least about 120 m²/g, and whereby a second TiO₂ component is crystalline TiO₂ with a specific surface area according to BET of less than about 50 m²/g.

9. The method of claim 8, whereby:
the TiO₂ components originate from the sulphate process for producing titanium dioxide.

10. The method of claim 8, whereby:
the first and the second TiO₂ components are mixed at a weight ratio of 1:1000 to 1000:1.

11. The method of claim 8 whereby:
the first and the second TiO₂ components are mixed at a weight ratio of 1:100 to 100:1.

12. The method of claim 8 whereby:
the first and the second TiO₂ components are mixed at a weight ratio of 1:10 to 10:1.

13. The method of claim 8 wherein:
the first TiO₂ component displays a particle size under about 30 nm and the second TiO₂ component displays a particle size over about 100 nm.

14. A method for manufacturing a material comprising a photocatalyst based on titanium dioxide whereby:
said photocatalyst displays a bimodal particle size distribution of primary particles, with one component under about 30 nm and a second component over about 100 nm.

15. The method of claim 14 further including:
incorporating the photocatalyst in a material selected from the group consisting of films, paints, plasters, lacquers, glazes on masonry, plaster surfaces, coatings, wallpapers, wood, metal, glass, plastic surfaces, ceramic surfaces, road surfacings, plastics, fibres and paper.

16. The method of claim 14 further including:
incorporating the photocatalyst in a material selected from the group consisting of cement, concrete, prefabricated concrete elements, roof tiles, ceramics, tiles, fabrics, panels, cladding elements for ceilings, indoor walls and outdoors walls.

17. The method of claim 14 further including:
processing the photocatalyst in a state selected from the group consisting of a dry state, a slurry and a matrix.
